(19) United States
(12) Patent Application Publication
(10) Pub. No.: US 2024/0232923 A1
(43) Pub. Date: Jul. 11, 2024

(54) INFORMATION PROCESSING METHOD

(71) Applicant: TOYOTA JIDOSHA KABUSHIKI KAISHA, Toyota-shi (JP)

(72) Inventors: Koki MORIYA, Nagakute-shi (JP); Hiroki TAKEISHI, Tokyo (JP); Ibuki SHIMADA, Miyoshi-shi (JP); Koji UEDA, Hunabashi-shi (JP); Ai MIYATA, Osaka (JP)

(73) Assignee: TOYOTA JIDOSHA KABUSHIKI KAISHA, Toyota-shi (JP)

(21) Appl. No.: 18/390,618

(22) Filed: Dec. 20, 2023

(30) Foreign Application Priority Data
Jan. 11, 2023 (JP) 2023-002626

(51) Int. Cl. G06Q 30/0207; B60L 58/27; G06Q 20/10; G06Q 30/0645

(52) U.S. Cl. CPC G06Q 30/0207; B60L 58/27; G06Q 20/102; G06Q 30/0645; B60L 2240/545; B60L 2260/56

(57) ABSTRACT

An information processing method using an information processing device, comprising acquiring temperature information of a battery of a vehicle, estimating a charging period of the vehicle and a charging fee corresponding to the charging period from the temperature information, and raising the temperature of the battery. Calculating the reduction amount of the charging fee when the work is performed, and notifying the user terminal of the work and the reduction amount.

### CROSS-REFERENCE TO RELATED APPLICATION

This application claims priority to Japanese Patent Application No. 2023-002626 filed on Jan. 11, 2023, incorporated herein by reference in its entirety.

### BACKGROUND

### 1. Technical Field

The present disclosure relates to an information processing method.

### 2. Description of Related Art

Hitherto, there is known a service in which a power supply vehicle rushes to a host vehicle and supplies electric power to the host vehicle when a power supply request to the host vehicle is made on an application (see, for example, NIO LIMITED, “NIO Power”, [online], 2022, [Searched on Dec. 14, 2022], Internet <URL: https://www.nio.com/nio-power>).

### SUMMARY

In association with rushing-to charging as the above-described background art, there is known a technique of calculating a charging fee by estimating a charging time zone, a charging amount, and man-hours, and requesting payment of the charging fee when receiving a reservation. However, the charging efficiency is decreased when a temperature of a battery of a vehicle is decreased, and thus the estimated cost may deviate from the actual cost.

An object of the present disclosure that has been made in view of such circumstances is to improve the estimation accuracy of the charging fee.

An information processing method according to an embodiment of the present disclosure is an information processing method to be performed by an information processing device, and includes: acquiring temperature information of a battery of a vehicle, and estimating, from the temperature information, a charging period of the vehicle and a charging fee in accordance with the charging period; and calculating a reduction amount of the charging fee when a work of raising a temperature of the battery is performed, and notifying a user terminal of the work and the reduction amount.

With the embodiment of the present disclosure, it is possible to improve the estimation accuracy of the charging fee.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system;

FIG. 2 is a block diagram showing the configuration of an information processing device;

FIG. 3 is a block diagram showing the configuration of a user terminal;

FIG. 4 is a block diagram showing the configuration of the vehicle;

FIG. 5 is a diagram showing an example of a display screen of a user terminal; and

FIG. 6 is a flowchart showing the operation of the information processing device.

### DETAILED DESCRIPTION OF EMBODIMENTS

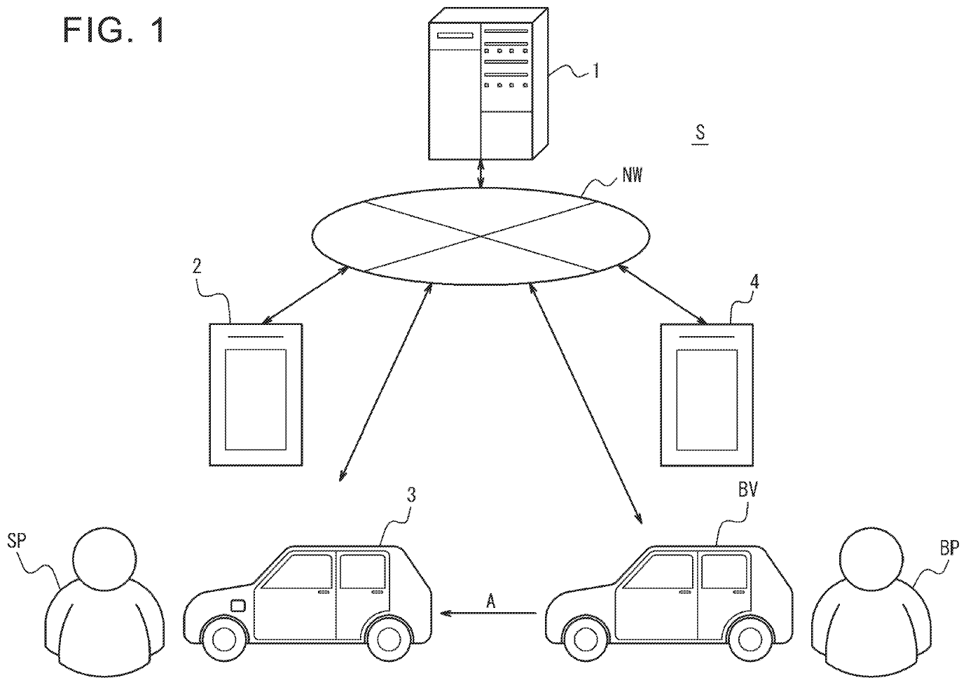

FIG. 1 is a schematic diagram of an information processing system S according to the present embodiment. The information processing system S includes an information processing device 1, a user terminal 2, a vehicle 3, a worker terminal 4, and a worker vehicle BV that can communicate with each other via a network NW. Network NW includes, for example, a mobile communication network, a fixed communication network, or the Internet. As an alternative, information processing device 1 may be mounted on vehicle 3.

The user terminal 2 is operated by the user SP. The user SP drives the vehicle 3 or gets into the vehicle 3. The worker terminal 4 is operated by the worker BP. The worker BP drives or rides the worker vehicle BV. The worker vehicle BV moves to the position of the vehicle 3 in direction A, and supplies electric power from the worker vehicle BV to the vehicle 3. As an example here, each of the worker vehicle BV and the vehicle 3 is a battery electric vehicle including a battery, but is not limited to this. Alternatively, the vehicle 3 may receive power from the charging device.

In FIG. 1, one information processing device 1, one user terminal 2, and one vehicle 3 are illustrated for the sake of simplicity of explanation. However, the number of each of the information processing device 1, the user terminal 2, and the vehicle 3 is not limited to one. For example, the processes executed by the information processing device 1 according to the present embodiment may be executed by a plurality of the information processing devices 1 disposed in a distributed manner.

The information processing device 1 is installed in facilities such as a data center. The information processing device 1 is, for example, a computer such as a server belonging to a cloud computing system or other computing systems.

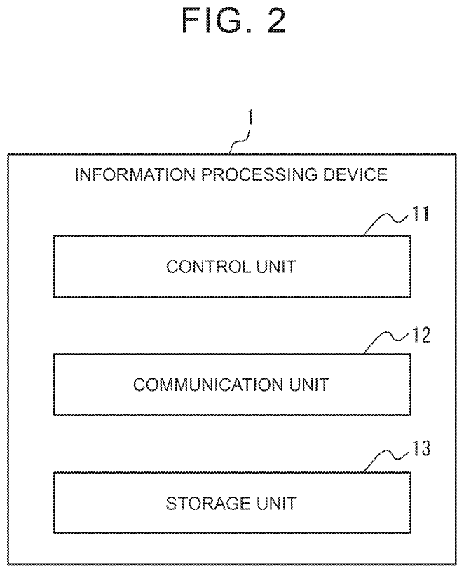

In FIG. 2, the internal configuration of the information processing device 1 will be described in detail.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including a Central Processing Unit (CPU) or a Micro Processing Unit (MPU). The control unit 11 may include one or more dedicated processors specialized for a specific process. The control unit 11 may include one or more dedicated circuits instead of including the processor. A dedicated circuit may be, for example, a Field-Programmable Gate Array (FPGA) or an Application Specific Integrated Circuit (ASIC). The control unit 11 may include an Electronic Control Unit (ECU). The control unit 11 transmits and receives information via the communication unit 12.

The communication unit 12 includes communication modules compatible with one or more wired or wireless Local Area Network (LAN) standards for connecting to the network NW. The communication unit 12 may include modules compatible with one or more mobile communication standards including Long Term Evolution (LTE), 4th Generation (4G), or 5th Generation (5G). The communication unit 12 may include a communication module and the like conforming to one or more short-range communication standards or specifications including Bluetooth (registered trademark), AirDrop (registered trademark), infrared data association (IrDA), ZigBee (registered trademark), FeliCa (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the disclosure is not limited to this. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read-only memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 may be provided outside the information processing device 1 and accessed from the information processing device 1.

The user terminal 2 is, for example, a mobile terminal such as a mobile phone, a smart phone, a wearable device, or a tablet. Alternatively, the user terminal 2 may be a general purpose device such as a PC, or a dedicated device. The term “PC” is an abbreviation for “personal computer”.

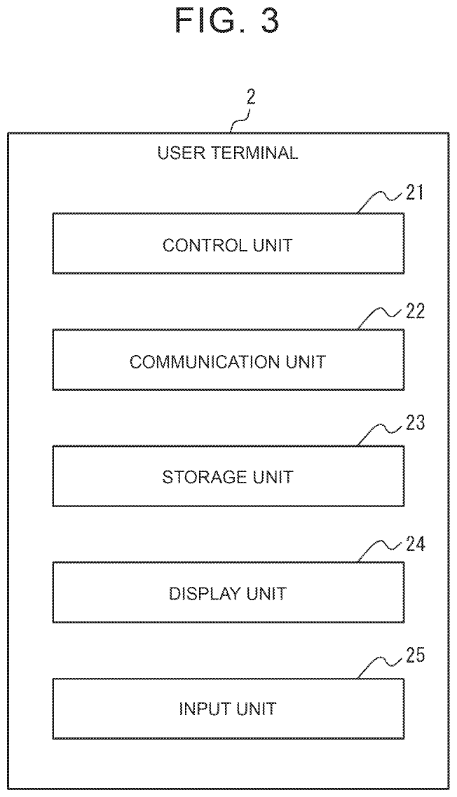

In FIG. 3, the internal configuration of the user terminal 2 is explained in detail.

The user terminal 2 includes a control unit 21, a communication unit 22, a storage unit 23, a display unit 24 and an input unit 25. Each component of the user terminal 2 is communicably connected to each other via a dedicated line, for example.

The description of the hardware configuration of the control unit 21, the communication unit 22, and the storage unit 23 of the user terminal 2 may be the same as the description of the hardware configuration of the control unit 11, the communication unit 12, and the storage unit 13 of the information processing device 1. The description here is omitted.

The display unit 24 is, for example, a display. The display is, for example, an LCD or an organic EL display. The term “LCD” is an abbreviation for “liquid crystal display”. The term “EL” is an abbreviation for “electroluminescence”. The display unit 24 may be connected to the user terminal 2 as an external output device instead of being provided in the user terminal 2. As a connection method, for example, any method such as a universal serial bus (USB), a high-definition multimedia interface (HDMI) (registered trademark), or Bluetooth (registered trademark) can be used.

The input unit 25 is, for example, a physical key, a capacitive key, a pointing device, a touch screen integrated with a display, or a microphone. The input unit 25 receives an operation of inputting information used for the operation of the user terminal 2. The input unit 25 may be connected to the user terminal 2 as an external input device instead of being provided in the user terminal 2. As a connection method, for example, any method such as a universal serial bus (USB), a high-definition multimedia interface (HDMI) (registered trademark), or Bluetooth (registered trademark) can be used. The term “USB” is an abbreviation for “universal serial bus”. The term “HDMI (registered trademark)” is an abbreviation for “high-definition multimedia interface”.

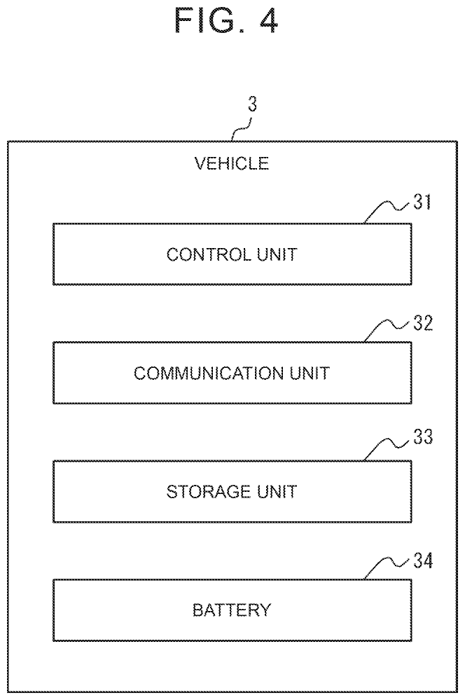

In FIG. 4, the internal configuration of the vehicle 3 will be explained in detail. Vehicle 3 includes control unit 31, communication unit 32, storage unit 33 and battery 34. Each component of the vehicle 3 is communicably connected to each other via a dedicated line, for example.

The description of the hardware configuration of the control unit 31, the communication unit 32, and the storage unit 33 of the vehicle 3 is the same as the description of the hardware configuration of the control unit 21, the communication unit 22, and the storage unit 23 of the user terminal 2. It can be. The description here is omitted.

The description of the hardware configuration of the worker terminal 4 may be the same as the description of the hardware configuration of the user terminal 2. The description of the hardware configuration of worker vehicle BV may be the same as the description of the hardware configuration of vehicle 3.

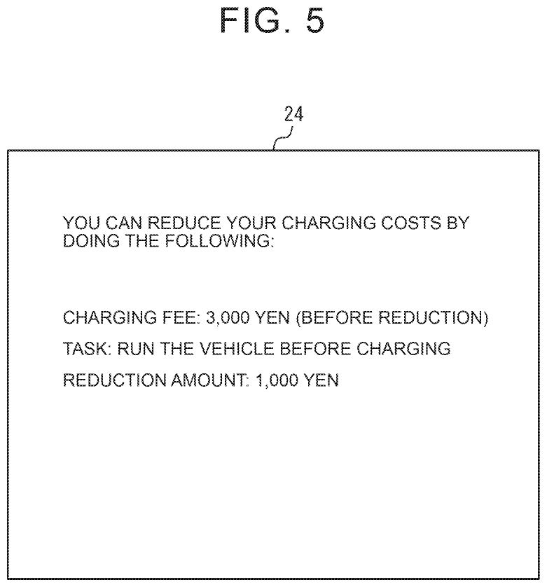

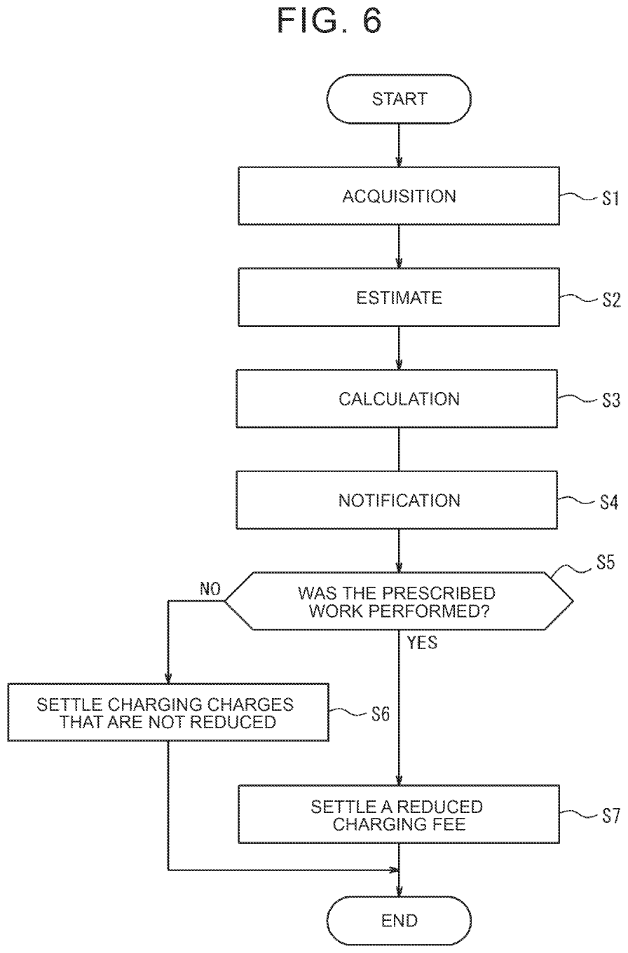

Hereinafter, the information processing method by the information processing device 1 will be described in detail with reference to FIGS. 5 and 6. Here, as an example, a scene in which the user SP operates the input unit 25 of the user terminal 2 to request power supply to the vehicle 3 will be described.

In S1 of FIG. 6, the control unit 11 acquires temperature information of the battery 34 of the vehicle 3 from the vehicle 3 upon receiving a power supply request from the user terminal 2. Alternatively, the control unit 11 may acquire temperature information by estimating the temperature of the battery 34 from at least one of the season and the travel history of the vehicle 3. As another alternative example, when the control unit 11 determines that the vehicle 3 is a rental car, the control unit 11 determines vehicle data (e.g., travel data) of another vehicle (e.g., a registered private car of the user SP that is routinely used by the user SP) and calculating the temperature of the battery 34 from the vehicle data.

In S2, the control unit 11 estimates the charging period and the charging fee according to the charging period from the acquired temperature information. Any estimation method can be used.

In S3, the control unit 11 calculates the reduction amount of the charging fee when the predetermined work of raising the temperature of the battery 34 is performed. The predetermined work may be, for example, running the vehicle 3 before charging.

In S4, the control unit 11 notifies the user terminal 2 of at least the predetermined work and the reduction amount, as shown in FIG. 5.

In S5 of FIG. 6, the control unit 11 determines whether or not the predetermined work has been performed. The determination may be made by acquiring temperature information of the battery 34, acquiring change in position information of the vehicle 3, or the like.

When No in S5, the control unit 11 settles the charging fee for which the reduction amount is not reduced (3,000 yen in the example of FIG. 5) in S6. For example, the control unit 11 subtracts the charging fee from the balance stored in the account of the user of the user terminal 2.

When Yes in S5, the control unit 11 settles the charging fee with the reduced amount (2,000 yen in the example of FIG. 5) in S7.

The charging fee may be settled at any time before or after charging. That is, either pre-payment or post-payment may be performed. For example, when payment is made after charging, the control unit 11 pays the charging fee reflecting the determination result as to whether to reduce the reduction amount. As an alternative example, when payment is made before charging, the control unit 11 pays the charging fee after the reduction amount has been reduced before charging, and after charging, a predetermined operation of raising the temperature of the battery 34 is performed. If it is determined that it is not, the reduced amount may be additionally settled.

As an alternative or additional example, when the control unit 11 detects that the user SP has selected in the user terminal 2 to raise the temperature of the battery 34, the control unit 11 assigns the operation authority of the heater of the battery 34 to the worker performing charging. It may be given to the worker terminal 4 of the worker BP. For example, the control unit 11 may transmit the digital key of the vehicle 3 to the worker terminal 4. The worker BP uses the operation authority to operate the heater to raise the temperature of the battery 34. When the vehicle 3 is left in a stopped state, the battery 34 cools particularly in cold regions. Therefore, operating the heater of the battery 34 is effective in raising the temperature.

As described above, according to the present embodiment, the operation of the control unit 11 of the information processing device 1 includes: acquiring temperature information of the battery 34, and estimating a charging period of the vehicle 3 and a charging fee according to the charging period from the temperature information; and calculating the reduction amount of the charging fee when the work of raising the temperature of the battery 34 is executed, and notifying the user terminal 2 of the work and the reduction amount. With this configuration, the information processing device 1 obtains the temperature information of the battery 34 and reflects it in the estimation, so that the estimation accuracy of the charging fee can be improved.

Further, according to the present embodiment, the operation of the control unit 11 includes: settling the charging fee after the reduction amount is reduced before charging; and settlement of the reduced amount upon determining after charging that the work has not been performed. With this configuration, the information processing device 1 can reliably perform payment even when advance payment is set.

Further, according to the present embodiment, when it is detected that the user SP has selected to raise the temperature of the battery 34, the operation of the control unit 11 gives the operation authority of the heater of the battery 34 to the worker terminal 4 of the worker who performs charging. With this configuration, the information processing device 1 can ensure that the temperature raising operation is reliably performed by the operator.

Further, according to this embodiment, the operation of the control unit 11 includes obtaining temperature information by estimating the temperature of the battery 34 from at least one of the season and the travel history of the vehicle. With this configuration, the information processing device 1 can further improve the estimation accuracy of the charging fee.

Further, according to the present embodiment, when the vehicle 3 is determined to be a rental car, the operation of the control unit 11 includes acquiring temperature information by acquiring vehicle data of another vehicle that is routinely used by the user SP. With this configuration, the information processing device 1 can reflect the user's individuality such as daily habits, so that the charging rate estimation accuracy can be further improved.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or step can be rearranged so as not to be logically inconsistent, and a plurality of means or steps can be combined into one or divided.

For example, in the above-described embodiments, a program for executing all or part of the functions or processes of the information processing device 1, the user terminal 2, and the vehicle 3 can be recorded in a computer-readable recording medium. The computer-readable recording medium includes a non-transitory computer-readable medium such as a magnetic recording device, an optical disc, a magneto-optical recording medium, or a semiconductor memory. Program distribution is performed by selling, assigning, or lending a portable recording medium such as a Digital Versatile Disc (DVD) or a Compact Disc Read Only Memory (CD-ROM) on which the program is recorded, for example. Further, the distribution of the program may be performed by storing the program in a storage of a server and transmitting the program from the server to another computer. Further, the program may be provided as a program product. The present disclosure can also be realized as a program that can be executed by a processor.

What is claimed is:

1. An information processing method to be performed by an information processing device, the information processing method comprising:
acquiring temperature information of a battery of a vehicle, and estimating, from the temperature information, a charging period of the vehicle and a charging fee in accordance with the charging period; and
calculating a reduction amount of the charging fee when a work of raising a temperature of the battery is performed, and notifying a user terminal of the work and the reduction amount.

2. The information processing method according to claim 1, further comprising:
settling the charging fee after reduction of the reduction amount, before charging; and
settling the reduced amount, when determination is made after the charging that the work is not performed.

3. The information processing method according to claim 1, further comprising granting an operation authority of a heater of the battery to a worker terminal of a worker that performs charging, when selection by a user to raise the temperature of the battery is detected.

4. The information processing method according to claim 1, further comprising acquiring the temperature information by estimating the temperature of the battery from at least one of a season and a traveling history of the vehicle.

5. The information processing method according to claim 1, further comprising acquiring the temperature information by acquiring vehicle data of another vehicle routinely used by a user, when determination is made that the vehicle is a rental car.
